(19) United States
(12) Patent Application Publication
(10) Pub. No.: US 2026/0132879 A1
(43) Pub. Date: May 14, 2026

(54) Installation Fitting

(71) Applicant: Georg Fischer Rohrleitungssysteme AG, Schaffhausen (CH)

(72) Inventors: Marcel GRAF, Neuhausen Am Rheinfall (CH); Juergen ROESCH, Lenzkirch (DE); Florian BRUGGER, Donaueschingen (DE); Christian SCHIEFER, Rheinheim (DE); Katja ATZENHOFER, Zürich (DE)

(21) Appl. No.: 19/384,170

(22) Filed: Nov. 10, 2025

(30) Foreign Application Priority Data
Nov. 12, 2024 (EP) 24212470.9

(51) Int. Cl. F16L 55/07; G01D 11/30

(52) U.S. Cl. CPC F16L 55/07; G01D 11/30

(57) ABSTRACT

A fitting for installing screw-in connectors, preferably sensors having threads, in a pipe, comprising an outer diameter, an inner diameter, a length and a longitudinal axis, the fitting being made of plastic and in the form of an injection-moulded part, wherein multiple eyes are arranged on the outer circumference, each eye having a central axis perpendicular to the longitudinal axis.

### CROSS-REFERENCE TO RELATED APPLICATIONS

This application claims the benefit and priority of European Patent Application No. 24212470.9 filed Nov. 12, 2024. The entire disclosure of the above application is incorporated herein by reference.

### BACKGROUND OF THE INVENTION

### Technical Field

The invention relates to a fitting for installing screw-in connectors, preferably sensors having threads, in a pipe, comprising an outer diameter, an inner diameter, a length and a longitudinal axis, the fitting being made of plastic and in the form of an injection-moulded part.

### Discussion

In order to fix sensors having threads in a pipe, a bore is usually introduced into the existing pipe, inserted into which is an outgoing nozzle via which a sensor receives direct access to the medium. The disadvantage of this is that it is usually not possible to fix such outgoing nozzles in thin-walled tubes, and so what is generally fitted into the existing pipe is a fitting having a portion of increased wall thickness that allows fixing of an outgoing nozzle.

DE 10 2013 015 038 A1 discloses a measuring tube for a flow meter, in which the branch tube is joined to the pipe. The disadvantage of this is that the pipe must have a certain wall thickness to allow stable fixing of the branch tube.

Utility model DE 20 2005 013 904 U1 discloses a tube comprising a sensor adapter which is attached to the tube by means of a bayonet closure and in which a sensor is then accommodated. The disadvantage of this is that only one sensor adapter can be arranged at one position on the tube and no other sensors can be arranged on the same length of pipe along the tube circumference.

It is an aspect of the invention to provide a fitting that enables multiple connectors for, for example, sensors to be fixed at one point on the pipe or on one length of the pipe, which connectors can moreover be mounted on the fitting easily and precisely.

### SUMMARY

This aspect is achieved by multiple eyes being arranged on the outer circumference, each eye having a central axis perpendicular to the longitudinal axis.

The fitting of the invention for installing connectors, preferably sensors, in a pipe comprises an outer diameter, an inner diameter, a length and a longitudinal axis. The fitting is made of plastic and in the form of an injection-moulded part; this allows mass production. Multiple eyes are arranged on the outer circumference, each eye having a central axis perpendicular to the longitudinal axis. The eyes serve for accommodating connectors, preferably sensors, which then protrude into the pipe and measure the desired properties of the medium.

It is advantageous when the eyes have a round base perpendicular to the central axis. This provides the screw-in connector or sensor with a good contact surface. It is advantageous when all eyes on the fitting have the same dimensions.

It is advantageous when the eyes extend cylindrically or conically along the central axis. The eyes extend beyond the outer diameter of the fitting.

Preferably, the eyes have a central bore. The bore is preferably in the form of a blind hole and does not extend through the wall of the fitting. Preferably, a small indentation at the bottom of the blind hole serves as pre-centring, by means of which the bore is additionally completely bored through in the case of use of a connector or sensor, and the connector or the sensor is arranged therein.

It has been found to be preferable when more than two eyes are arranged on the fitting, which has advantage of only having to fit one fitting in the pipe and of multiple possible sensor connections being available at the same time.

It is advantageous when four eyes are arranged on the outer circumference with a regular distribution. This means that the eyes are preferably arranged around the longitudinal axis or outer circumference offset from one another by 90° and are at the same height of the longitudinal axis of the fitting.

It has been found to be advantageous when the eyes lie in a plane perpendicular to the longitudinal axis. This enables multiple, preferably four, sensors to be fitted in confined spaces.

Preferably, arranged on the outer circumference between the eyes is a connecting portion extending around the circumference. It serves for stabilization of the eyes on the fitting.

It has been found to be preferable when the fitting is made of one of the plastics PEEK, PVDF, ECTFE, PVC, PP, PE or Peek.

It is advantageous when the eyes are arranged in the middle of the length of the fitting. This ensures optimum access for mounting the connectors or sensors when the fitting is fitted in the pipe.

All the possible configurations can be freely combined with one another.

An exemplary embodiment of the invention will be described with reference to the drawings, but without limiting the invention to just the exemplary embodiment. In the drawings:

### BRIEF DESCRIPTION OF THE DRAWINGS

FIG. 1 shows a three-dimensional fitting according to the invention,

FIG. 2 shows a longitudinal section through a fitting according to the invention,

FIG. 3 shows a side view of a fitting according to the invention comprising a fitted sensor.

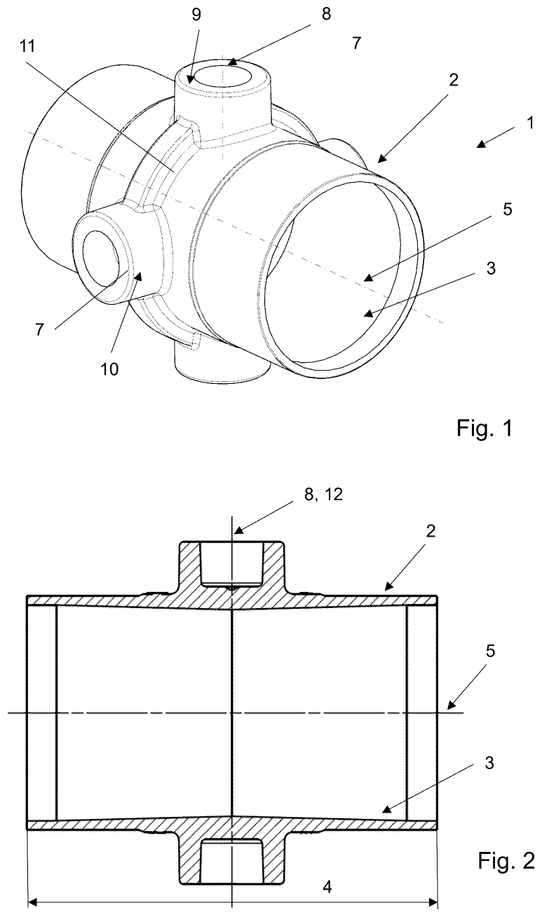

### DESCRIPTION OF THE PREFERRED EMBODIMENTS OF THE INVENTION

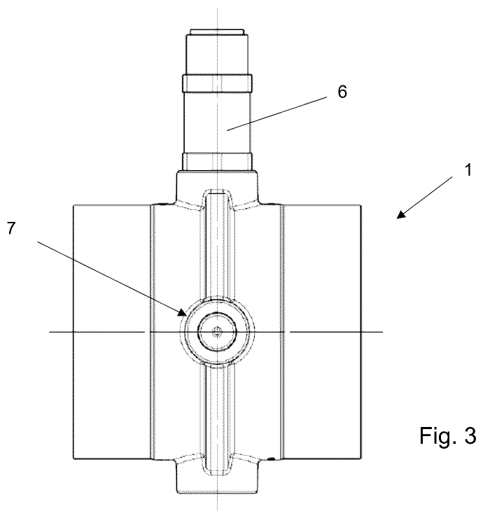

The drawing shown in FIG. 1 shows a fitting 1 according to the invention for installing sensors 6 in a pipe. The fitting 1 has an outer diameter 2, an inner diameter 3 and a length 4. Arranged on the outer diameter 2 are multiple eyes 7 for sensor accommodation 6. The central axes 8 of the eyes 7 are perpendicular to the longitudinal axis 5. The eyes 7 of the fitting 1 preferably have a round base 9, said base 9 being horizontal in relation to the central axis 8 of the eye 7. The base 9 ensures a flat contact surface for the sensor 6, which can be clearly seen in FIG. 3. It is advantageous when four eyes 7 are arranged on the outer circumference of the fitting 1. This allows the possibility of being able to fit four sensors 6 even in confined spaces. Moreover, it has the advantage of only having to fit one fitting 1 in a pipe in order to provide four sensors 6 on the pipe. The eyes 7 preferably have a cylindrical or conical shape, i.e. extend cylindrically or conically along the central axis 8, and extend beyond the outer diameter of the fitting 1. It is advantageous when a bore 10 extending along the central axis 8 is arranged in the eye 7, and a small indentation at the bottom of the blind hole serves for pre-centring for the subsequent boring to accommodate a sensor 6 in the eye 7. The bore 10 is thus only in the form of a blind hole and is bored through when arranging a sensor 6 therein, otherwise the bore 10 remains as a blind hole without access to the medium. It is advantageous when the eyes 7 are distributed at regular intervals around the outer circumference; this means that, in the case of four eyes 7 on the fitting 1, the eyes 7 are arranged around the longitudinal axis 5 offset from each other by 90°. Similarly, it is advantageous when all eyes 7 are arranged in one plane relative to the longitudinal axis, i.e. at the same height of the longitudinal axis 5, preferably in the middle of the length of the fitting 1. In order to increase the stability of the eyes 7, a connecting portion 11 extends along the outer circumference between the eyes 7. This ensures, even in the case of a thin-walled fitting 1, that the eyes 7 are arranged stably on the fitting 1.

What is claimed is:

1. A fitting (1) for installing screw-in connectors (6) comprising an outer diameter (2), an inner diameter (3), a length (4) and a longitudinal axis (5), the fitting (1) being made of plastic and in the form of an injection-moulded part, wherein multiple eyes (7) are arranged on the outer circumference (2), each eye (7) having a central axis (8) perpendicular to the longitudinal axis (5).

2. A fitting (1) according to claim 1, wherein the eyes (7) have a round base (9) perpendicular to the central axis (8).

3. A fitting (1) according to claim 1, wherein each eye (7) extends cylindrically or conically along the central axis (8).

4. A fitting (1) according to claim 1, wherein the eyes (7) have a central blind hole (10).

5. A fitting (1) according to claim 1, wherein more than two eyes (7) are arranged on the fitting (1).

6. A fitting (1) according to claim 1, wherein four eyes (7) are arranged on the outer circumference with a regular distribution.

7. A fitting (1) according to claim 1, wherein the eyes (7) lie on a plane perpendicular to the longitudinal axis (5).

8. A fitting (1) according to claim 1, wherein there is arranged a connecting portion extending on the outer circumference (2) between the eyes (7).

9. A fitting (1) according to claim 1, wherein the fitting (1) is made of one of the plastics PEEK, PVDF, ECTFE, PVC, PP, PE or Peek.

10. A fitting (1) according to claim 1, wherein the eyes (7) are arranged in the middle of the length (4) of the fitting (1).
